(19) United States
(12) Patent Application Publication
(10) Pub. No.: US 2024/0385281 A1
(43) Pub. Date: Nov. 21, 2024

(54) Radar Sensor Device, Radar System with a Corresponding Radar Sensor Device, Motor Vehicle, Method for Operating and Method for Producing a Radar Sensor Device

(71) Applicants: Volkswagen Aktiengesellschaft, Wolfsburg (DE); AUDI AG, Ingolstadt (DE)

(72) Inventors: Heiko KURZ, Hannover (DE); Rachid KHLIFI, Garching bei Muenchen (DE)

(73) Assignees: Volkswagen Aktiengesellschaft, Wolfsburg (DE); AUDI AG, Ingolstadt (DE)

(21) Appl. No.: 18/557,513

(22) PCT Filed: Apr. 14, 2022
(86) PCT No.: PCT/EP2022/060117

§ 371 Date: Oct. 26, 2023

(30) Foreign Application Priority Data
Apr. 28, 2021 (DE) 10 2021 110 820.9

(51) Int. Cl. G01S 7/00; G01S 7/02; G01S 7/03; G01S 7/35; G01S 13/34; G01S 13/931

(52) U.S. Cl. CPC G01S 7/003; G01S 7/028; G01S 7/032; G01S 7/358; G01S 13/34; G01S 13/931

(57) ABSTRACT

The disclosure relates to a radar sensor device comprising a transmission path and a reception path, an optical input, which is formed for receiving an optical transfer signal, an optical output, which is formed for providing an optical output signal, an antenna, which is configured to transmit an electrical transmission signal and to receive an electrical reception signal, a digital interface unit, which is configured to switch between the transmission path and the reception path, wherein the radar sensor device is formed as a system on a chip, and the transmission path, the reception path, the optical input, the optical output, the antenna and the digital interface unit are arranged on the system on a chip.

### CROSS-REFERENCE TO RELATED APPLICATIONS

This application claims priority to German Patent Application No. 10 2021 110 820.9, filed on Apr. 28, 2021 with the German Patent and Trademark Office. The contents of the aforesaid Patent Application are incorporated herein for all purposes.

### TECHNICAL FIELD

The invention relates to a radar sensor device. Furthermore, the invention relates to a radar system with at least one corresponding radar sensor device and a central electronic computing device. The invention also relates to a motor vehicle with a corresponding radar system. Furthermore, the invention relates to a method for operating a corresponding radar sensor device. The invention also relates to a method for producing a corresponding radar sensor device.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

From EP 3 196 694 A1, an analog-digital converter for optically sampling signals is known. With the aid of this converter, an analog signal can be converted into a digital signal.

### SUMMARY

A need exists to improve the integration capability of a radar sensor device for the employment of a radar sensor device in a radar system.

The need is addressed by a radar sensor device, a radar system, a motor vehicle, and various methods according to the independent claims. Embodiments are apparent from the dependent claims, the specification, and the drawings.

### BRIEF DESCRIPTION OF THE DRAWINGS

FIG. 1 shows a schematic representation of an example motor vehicle with an example radar system, which comprises a radar sensor device and a central electronic computing device; and

FIG. 2 shows a schematic block diagram of the radar sensor device from FIG. 1.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments relate to a radar sensor device comprising:
a transmission path,
a reception path different from the transmission path,
an optical input, which is a constituent of the transmission path and which is formed for receiving an optical transfer signal,
an optical output, which is a constituent of the reception path and which is formed for providing an optical output signal,
an antenna, which is configured to transmit an electrical transmission signal, which is based on the optical transfer signal, and to receive an electrical reception signal,
a digital interface unit, which is configured to switch between the transmission path for transmitting the electrical transmission signal and the reception path for receiving the electrical reception signal, wherein
the radar sensor device is formed as a system on a chip, and
the transmission path, the reception path, the optical input, the optical output, the antenna and the digital interface unit are arranged on the system on a chip.

A benefit of the disclosure is that the radar sensor device can be better integrated in radar systems by the use of a system on a chip. By the use of a system on a chip, the radar sensor device can be more compactly designed. By the integration of the components of the radar sensor device on the system on a chip, costs can be reduced in the manufacture of the radar sensor device since various designs or chip types are not required for a transmission path and for a reception path.

With the proposed radar sensor device, high data loads of more than 1 Gb/s per antenna can in particular be prevented in coherent processings of radar data from radar systems with distributed antennas. By the integration of all of the components of the radar sensor device on the system on a chip, a reduction of the data load in radar systems with many, distributed antennas can be achieved.

By a system on a chip (SoC), an integration of all or of a large part of the functions of a programmable electronic system on a chip is understood. The SoC thus may be an integrated circuit (“IC”) on a semiconductor substrate, e.g., one using ‘monolithic integration’. For example, when silicon is used as the substrate material, one also speaks of system on silicon (SoS) in this case. A combination of different elements, such as for example logical circuits, clocking, autonomous startup, microtechnical sensors etc., can be construed as a system on a chip, which together provide a certain functionality, for example a sensor along with evaluation electronics. Such systems on a chip are for example used in embedded systems. While conventional systems were initially also composed of a microprocessor or microcontroller IC and many other ICs for special functions, which were soldered to a board, by the integration density of the system on a chip, nearly all of the functions can be combined on a single IC. Therein, digital, analog and mixed signal function units can be integrated. Therein, the benefit arises that cost saving, lower energy consumption or power loss and comprehensive miniaturization can especially be provided.

In other words, all of the components of the radar sensor device are integrated on a single integrated circuit IC. Accordingly, the functionality of the radar sensor device can be performed with only one single integrated circuit IC or one single chip. Put another way, the radar sensor device is fully functional as a standalone unit. By the use of a single chip or integrated circuit, the radar data are electronically transferred on the radar sensor device.

In particular, the system on a chip is a single semiconductor chip for T, and R, channel. For example, the system on a chip can be produced based on a CMOS, SiN-CMOS, Bi-CMOS or a hybrid Bi-CMOS process. In particular, the system on a chip is a photonically-electronically cointegrated chip or semiconductor chip. The entire components of the radar sensor device are integrated or arranged on it.

A further benefit is in that a cointegration of optical and electrical members is effected on the system on a chip for generating and for receiving radar signals. By the cointegration of optical and electrical members, the complexity of the radar sensor device and thus of a radar system can be reduced. By the use of a single chip design or integrated circuit for all of the members of the radar sensor device, a production process of the radar sensor device can also be simpler and more inexpensively realized.

With the aid of the radar sensor device, a reduction of a data transfer load in radar systems, in which the radar sensor device is employed as intended, with distributed antennas can be realized. For example, the radar sensor device can be used in radar systems for motor vehicles. The radar sensor device can also be employed in very different technical fields of application. For example, the radar sensor device can be applied in the aeronautical technology, shipping technology, in the automation technology or in the communication technology.

In particular, such a radar sensor device can be employed for example in at least partially autonomously operated motor vehicles, but in particular also in fully autonomously operated motor vehicles. However, in order to allow such an automated drive, a safe environmental perception is indispensable. Therein, the environment or the surroundings is captured with the aid of sensors like radar, lidar and cameras. An integral, 360-degree three-dimensional capture of the environment is particularly important such that all of the static and dynamic objects can be captured. In particular in lidar, the redundant, robust environmental capture plays a major role since this type of sensor can precisely measure distances in the environmental capture and can also be employed for classification. However, these lidar sensors are cost-intensive and expensive in their construction. In particular a 360-degree three-dimensional environmental capture is problematic since either many smaller individual sensors are required to ensure it, which usually operate with many individual light sources and detector elements, or large lidar sensors are installed. Furthermore, lidar sensors are prone to weather influences like rain, fog or direct solar radiation. Herein, a radar sensor device can provide a remedy.

Radar sensors or radar sensor devices are also established from the motor vehicle construction and provide data under all weather conditions in reliable and failsafe manner. Even poor visibility conditions such as for example rain, fog, snow, dust and darkness barely influence their perception reliably. However, the resolution is restricted up to now, in particular since series radars being employed are only formed with a resolution of about 7°. In order to achieve the requirements for an increased automation level in the motor vehicle construction with safe drive functions, it is provided that the radar sensor device provides three-dimensional images with a high resolution in the range of 0.1° and below with a great insensitivity with respect to interferences from its environment. This is not achieved with the conventional radar technology since the resolution of such systems is too low. In order to be able to considerably increase the resolution, the radar sensor device according to the teachings herein can be used. By the cointegration of electronic and photonic components on the system on a chip, thus, on a single semiconductor chip, the resolution of photonic radar systems, in which the radar sensor device is used, can be increased.

For example, a silicon photonics technology can be used for the cointegration of the photonic and electronic members on the system on a chip. This allows the monolithic integration of photonic members, high-frequency electronics and digital electronics in common on a single integrated circuit or chip. Such a system offers the benefit that a signal transfer of GHz signals can be performed by means of an optical carrier signal in the THz frequency range.

In particular, it can be achieved by the radar sensor device that various chip designs and various chip configurations for a transmission and reception channel can be omitted since they can be omitted by the system on a chip.

By the digital interface unit, the radar sensor device can be equipped with a dual function or dual functionality. Accordingly, both radar signals can be received and radar signals can be transmitted by the radar sensor device. Thus, the transmission and reception are effected on one and the same semiconductor chip. In particular, the digital interface unit is an integrated digital interface on the photonically-electronically cointegrated semiconductor chip, also referred to as EPIC chip.

With the digital interface unit, it can in particular be selectively switched between the transmission path and the reception path. In other words, the radar sensor device can be set either into a transmission mode or into a reception mode or be operated therein by the digital interface unit. Thus, either the electrical transmission signal can be transmitted or the electrical reception signal can be received. The electrical transmission signal is based on the optical transfer signal. The electrical reception signal can be a signal corresponding to the electrical transmission signal and reflected in an environment of the radar transmission device.

In particular, a transmission chip and a reception chip can be omitted by the radar sensor device since both the transmission function and the reception function can be realized on a single integrated circuit by the system on a chip.

For example, the optical transfer signal is an optical carrier signal in the THz frequency range. For example, the electrical reception signal can be referred to as radar echo signal.

For example, the radar sensor device and in particular the system on a chip can be realized in the form of hybrid BI-CMOS (SIGE) or CMOS (SIN) circuits. Therein, conventional transistors and waveguide structures and/or electrooptical modulators are combined in the silicon.

In particular, the proposed radar sensor device allows adaptation of the modulation method and the sampling behavior. Therein, the measurement duration, chirp sequence and the sampling rate can in particular be accommodated or adapted.

For example, the antenna can be formed as an exchangeable antenna such that the antenna can be exchanged according to case of application of the radar sensor device. Optionally, it can also be provided that the radar sensor device each contains an antenna for transmitting and an antenna for receiving. In other words, both the reception path and the transmission path can each comprise an antenna.

In some embodiments, it is provided that the radar sensor device comprises a transformation device, which is arranged on the system on a chip and is formed to generate the electrical transmission signal depending on the received optical transfer signal, in particular the transformation device comprises an optical photodiode for generating the electrical transmission signal depending on the transfer signal. In particular, the transformation device and the optical photodiode are arranged or integrated on the system on a chip. Accordingly, besides the previously cited members of the radar sensor device, the transformation device and the optical photodiode are also arranged or integrated on one and the same semiconductor chip or integrated circuit. In other words, the transformation device is a converter unit for converting optical signals into electrical signals. In particular, the transformation device is connected to the optical input in immediately adjoining manner. Thus, the received optical transfer signal can be converted into the electrical transmission signal after reception. In particular, the electrical transmission signal is produced or generated based on the optical transfer signal.

For example, the optical transfer signal can be referred to as optical radar driver signal.

For example, the optical input can be referred to as optical coupling element for coupling the optical transfer signal into the radar transmission device.

In particular, the conversion of the optical transfer signal can be effected by the optical photodiode of the transformation device. In other words, the optical photodiode is for example a fixed constituent of the transformation device.

For example, the transformation device can additionally comprise a check unit for monitoring the conversion operation from the optical transfer signal into the electrical transmission signal.

For example, the optical photodiode can be referred to as detector.

In particular, the transformation device and the optical photodiode are a constituent, in particular fixed constituent, of the transmission path of the radar sensor device. For example, the transmission path can be an electrical transmission path of the radar sensor device.

In some embodiments, it is provided that the transformation device additionally comprises an amplifier unit, wherein the amplifier unit is formed to increase a frequency of the electrical transmission signal generated by the optical photodiode depending on a preset carrier frequency. In particular, the amplifier unit is integrated in the transformation device or electrically, digitally linked to the transformation device. In particular, the amplifier unit is also integrated on the system on a chip. Optionally, the amplifier unit is a constituent of the transmission path.

For example, the amplifier unit can be a power amplifier, a multiplier unit. The amplifier unit is in particular formed to multiply the optical transfer signal from the frequency to the required carrier frequency and to provide it. This has the benefit that the optical transfer signal does not have to be provided with the full required carrier frequency. For example, it can be provided that a fraction of one eighth is selected. Thereby, the optical transfer signal can for example be modulated with one eighth of a radar frequency. Thus, the optical transfer signal is applied to the optical input with a considerably lower frequency compared to the frequency of the transmission signal. This allows a simpler and less complex transfer. In order to again obtain the frequency range of the optical carrier signal for transmitting the electrical transmission signal, the amplifier unit may be required.

With a carrier frequency of 77 GHz, the optical transfer signal, in particular the optical carrier signal, can for example be transferred or provided only with a frequency of 19.25 GHz. In the radar sensor device, the optical transfer signal can then be electrically multiplied by means of the amplifier unit and hereby be modulated or brought to the required carrier frequency. By the transfer of the optical transfer signal in a lower frequency range, a considerably lower amount of energy is required for transmitting and receiving the optical transfer signal. This can have beneficial effects with respect to the heat or the temperature of the radar sensor device.

In particular, the amplifier unit is directly immediately connected downstream of the optical photodiode.

In some embodiments, it is provided that the antenna and the digital interface unit are constituents of the transmission path and the reception path. In other words, the antenna and the digital interface unit are used both by the transmission path and by the reception path for transmitting and receiving. Accordingly, the antenna and the digital interface unit are active both in the transmission mode and in the reception mode of the radar sensor device. With the aid of the digital interface unit, the individual components or members of the radar sensor device can be activated or deactivated for the transmission path or the reception path. In particular, only the members of the radar sensor device are active in the transmission mode or transmission operation, which are required for transmitting the electrical transmission signal. In this state, the components, which are exclusively required for receiving signals, are in an inactive state. Conversely, only those members are active in a reception mode, which are required for receiving.

By the use of the antenna and the digital interface unit both for the transmission path and for the reception path, they have special characteristics. In particular, the antenna is formed as a multi-functional transmission and reception antenna. Thus, by the digital interface unit, the antenna can for example be correspondingly driven or a corresponding signal can be transmitted such that the antenna is switched or set either into the transmission mode or into the reception mode. By the use of a single antenna both for receiving and for transmitting signals, the radar sensor device and in particular the system on a chip can be more compactly and simpler configured. Thus, the required installation space or installation space requirement of the radar sensor device can in particular be kept low.

In some embodiments, it is furthermore provided that the transmission path between the digital interface unit and the antenna comprises at least one transmission amplifier unit, wherein the transmission amplifier unit is formed to increase a transmission power of the antenna for transmitting the electrical transmission signal. In particular, the transmission amplifier unit is a constituent of the transmission path. In particular, the transmission amplifier unit is arranged or integrated on the system on a chip.

In particular, the transmission amplifier unit is an electrical power amplifier, also referred to as “power amplifier”.

With the aid of the transmission power amplifier, in particular in the transmission mode, the electrical transmission signal can be adapted for transmission by means of the antenna. Therein, increase or amplification of the transmission power of the antenna is in particular effected. Thus, an improved transmission of the electrical transmission signal is effected, whereby the resolution of the radar sensor device and in particular of the radar system can in particular be increased. With the aid of the transmission amplifier unit, an improved signal transmission can in particular be performed.

In some embodiments, it is provided that the reception path between the digital interface unit and the antenna comprises a demodulation circuit, wherein the demodulation circuit is configured to mix the received electrical reception signal with the electrical transmission signal. In particular, the demodulation circuit is a constituent of the reception path of the radar sensor device. The demodulation circuit is also arranged or integrated on the system on a chip.

In particular, a digital modulation of the received electrical reception signal can be performed by the demodulation circuit. Hereto, an IQ modulation method, an amplitude modulation method, a frequency modulation method, a phase modulation method, an amplitude shift keying method, a frequency shift keying method, a phase shift keying method or an amplitude and phase shift keying method can for example be applied. By one of these modulation methods, bandwidth can in particular be saved in the transfer of data signals, here the electrical reception signal. Hereto, the demodulation circuit can for example comprise a baseband signal processing unit.

Furthermore, the demodulation circuit can for example additionally comprise a mixer, in particular an IQ mixer. This mixer can be formed to mix the electrical reception signal received from the antenna, in particular a radar echo signal, with the electrical transmission signal, in particular an electrical radar driver signal.

By the cointegration of the photonic and electronic components of the system on a chip, a purely electronic sampling of signals is in particular effected. By the demodulation circuit, downmixing of the received signal by an IQ mixer into the baseband is in particular effected.

In some embodiments, it is provided that the radar sensor device comprises a modulation device, which is arranged or integrated on the system on a chip and configured to generate the optical output signal depending on the electrical reception signal. In particular, the modulation device is configured to modulate the mixed signal onto the optical transfer signal and to provide it as an optical output signal at the optical output. In particular, the modulation device is a constituent of the reception path of the radar sensor device. In other words, the signal mixed by the demodulation circuit can be modulated onto the optical transfer signal by the modulation device and it can be provided to the optical output.

For example, the modulation device can additionally comprise a check unit and an amplifier (English: “TIA”). By the amplifier, the electrical reception signal can be correspondingly amplified and conditioned for the modulation. By means of the check unit, the conversion of the electrical signal into an optical output signal can be monitored.

In some embodiments, it is provided that the digital interface unit comprises an analog-digital converter, wherein the analog-digital converter is configured to digitally convert and digitally compress the received electrical reception signal. For example, the analog-digital converter can be referred to as analog/digital converter (ADC). With the aid of the analog-digital converter, digital data streams can be processed, further processed or forwarded. In particular, the data transfer for the transmission mode or the reception mode of the radar sensor device can be more robustly performed with the aid of the analog-digital converter. In particular, the analog-digital converter is a constituent of the digital interface unit and thus also arranged or integrated on the system on a chip. In particular, the analog-digital converter can be used both for the reception path and for the transmission path. Furthermore, the digital interface unit can comprise a compression interface and/or a data compression unit. By the compression interface and/or the data compression unit, a data load in receiving and in transmitting of the radar sensor device, the data load of the digital data can be reduced or decreased. By means of the digital interface unit, in particular by the individual, previously mentioned members of the digital interface unit, the received and downmixed radar raw data can in particular be digitally converted and compressed such that the arising data load can be reduced and this digital data can be provided for further processing.

In some embodiments, it is provided that the radar sensor device comprises at least one electrical output different from the optical output, which is arranged on the system on a chip and formed to, in particular directly, output the electrical reception signal of the reception path. Furthermore, the radar sensor device comprises a data pre-processing device, which is arranged on the system on a chip and by which the received electrical reception signal can be conditioned.

In particular, the electrical output and the data pre-processing device are a constituent of the reception path. Similarly, the electrical output and the data pre-processing device are arranged or integrated on one and the same integrated circuit of the system on a chip like all of the other components of the radar sensor device. By the additional electrical output, the received electrical reception signal can be directly output or provided to electrical computing units without conversion. For example, the electrical output can transfer the electrical reception signal via conventional copper cables for further processing. For example, the electrical reception signal digitally converted and digitally compressed by the analog-digital converter can be transferred via electrical signal lines without being optically converted. For example, the electrical output can be formed as a bidirectional interface. Thus, a bidirectional exchange of data can be effected via the electrical output. In particular, a bidirectional data transfer can be performed via electrical signal lines with the aid of the electrical output. By the use of the electrical output in addition to the optical output, the radar sensor device can provide very different possibilities for data output. Thus, the radar sensor device can be simpler and less complexly provided and conceived for very different fields of application.

For example, the data pre-processing device can be formed as an electrical, digital unit. In particular, the data pre-processing device can be referred to as pre-processing circuit. By the data pre-processing device, a signal pre-processing of the electrical reception signal can be performed. In addition to the digital interface unit, further data loads of the reception signal can be reduced with the aid of the data pre-processing device. Thus, the received data of the reception signal can be compressed. The sensor device can be operated more efficiently and freer of loss by the reduced data load.

For example, the data pre-processing device can be referred to as “low-level signal processing unit”. In particular, the data pre-processing device can comprise an integrated circuit, by means of which a discrete Fourier transform can be performed. In particular, the data pre-processing device can comprise an algorithm, by means of which a fast Fourier transform of the reception signal can be performed. Thus, the received reception signal can be decomposed into its frequency portions and thereby be analyzed. In particular, very different Fourier transforms can be performed by the data pre-processing device.

In some embodiments, the radar sensor device comprises a control device, which is arranged on the system on a chip and configured to drive the digital interface unit of the radar sensor device such that the radar sensor device is switched either to the transmission path or to the reception path, in particular wherein the control device comprises a data transfer bus system, wherein the control device is communicatively linked to the digital interface unit by the data transfer bus system. In particular, the control device is also arranged or integrated on the system on a chip, thus on the single electronic circuit, like the remaining components of the radar sensor device. In particular, the control device is a constituent of the transmission path as well as of the reception path.

With the aid of the control device, in particular an electronic control device, the digital interface unit can be driven such that the radar sensor device is switched either to the transmission mode or to the operating mode. Thus, the control device serves for controlling the digital interface unit and the antenna. In particular, it can be switched between the transmission mode and the reception mode with the aid of the control device. In particular, all of the members of the transmission path can be activated for the transmission path and all of the members of the reception path can be deactivated by the control device. The other way around, all of the components of the reception path can be activated for the reception path for receiving the reception signal and the components of the transmission path can be deactivated by the control device. In order to be able to drive the digital interface unit and in particular all of the components of the radar sensor device by the control device, the data transfer bus system is a part of the radar sensor device. In particular, the data transfer bus system is also arranged or integrated on the system on a chip. The data transfer bus system is in particular a communication network different from the transmission path and reception path. Multiple subscribers of the radar sensor device can exchange data with each other via a common transfer path with the aid of the data transfer bus system. For example, the data transfer bus system can be operated by means of various bus standards. Hereto, the standard PCI (peripheral component interconnect) can for example be used.

In particular, the control device is a diagnostic and control interface of the radar sensor device. By means of the diagnostic and control interface, the radar sensor device can be switched between the transmission mode and the reception mode. Thereto, an electrical control signal can for example be generated and for example be transferred to the digital interface unit by the control device.

For example, the control device can receive commands via the bidirectionally formed electrical output and perform or initiate switching between the transmission mode and the reception mode depending thereon.

For example, the control device can furthermore be configured to read out diagnostic data of the radar sensor devices. Therein, this diagnostic data can include a temperature of the radar sensor device, a period of time for transmitting or receiving, a ramp characteristic of the transmission signal, transmission information, reception information, a voltage value or a current value of the components of the radar sensor device or further information with respect to the components of the radar sensor device. This diagnostic data can be taken into account by the control device for switching between the transmission and reception mode.

A further aspect relates to a radar system with at least one radar sensor device according to the teachings herein or an embodiment thereof and a central electronic computing device, wherein the central electronic computing device is configured to generate the optical transfer signal for the radar sensor device and to receive the optical output signal, and the central electronic computing device is respectively coupled to the optical input and the optical output of the radar sensor device via at least one glass fiber.

Such a radar system can in particular be employed in motor vehicles or in automated systems or the aeronautical technology or in the aerospace technology.

In particular, the just proposed radar system can comprise the radar sensor device described according to the preceding aspect. In particular, the radar system can comprise multiple radar sensor devices. The previously described radar sensor device is in particular a cointegrated transmission and reception unit on one and the same system on a chip. This is for example beneficial in motor vehicles since a radar sensor system of a motor vehicle requires sensor systems circumferentially distributed on the motor vehicle. Thus, multiple radar sensor devices can be arranged distributed on the vehicle and they can be communicatively linked to each other via a central electronic computing device. Thus, the radar system only requires a central electronic computing device, in particular a central station. With the aid of the central electronic computing devices, very different radar sensor devices can be supplied by means of the optical transfer signal and the central electronic computing device can receive the optical output signals via the respective optical outputs of the radar sensor devices.

In particular, the central electronic computing device is a unit physically separated and different from the radar sensor. In particular, the central electronic computing device is not a constituent of the system on a chip of the radar sensor device. Compared to the system on a chip, the central electronic computing device can be a semiconductor chip or integrated circuit different therefrom.

By means of the central electronic computing device, tracking an FMCW signal as well as the entire signal processing and signal evaluation can for example be performed. The transmission and reception operations can in turn be performed by means of the radar sensor device.

In particular, the central electronic computing device can generate an optical carrier frequency in the Terahertz frequency range. The signal to be transferred, in particular the optical transfer signal, is modulated onto it with one eighth of the radar frequency of the radar system and transmitted to the radar sensor device per optical phase or amplitude modulation or frequency modulation. In this way, an eightfold increase of frequency occurs such that the radar radiation can be emitted by the antenna of the radar sensor device. The signal detection occurs in the reverse way. All of the data is processed on the central station, in particular the central electronic computing device.

The central electronic computing device is coupled to the optical input and the optical output of the radar sensor device via one or more glass fibers. Accordingly, the optical transfer signal, which has been generated by the central electronic computing device, is coupled into the glass fiber and transferred to the optical input of the radar sensor device via optical signal transfer. Thus, the transfer of the carrier signal or radar driver signal is effected via optical transfer paths. In particular, the glass fiber can be a glass fiber line. The central electronic computing device is also coupled to the optical output via a glass fiber. As a result, the radar sensor device, in particular the modulation device of the radar sensor device, can couple the optical output signal into the glass fiber and transfer it to the central electronic computing device for evaluating the received radar radiations.

In some embodiments of the present aspect, it is provided that the radar system comprises the central electronic computing device and an optical transmission unit, which is configured to generate the optical transfer signal and to couple it into the at least one glass fiber, which is coupled to the optical input of the radar sensor device. The central electronic computing device is also equipped with an optical reception unit, which is configured to receive the optical output signal via the at least one glass fiber, which is coupled to the optical output of the radar sensor device, and to determine radar information derived from it. In particular, the optical transfer signal can be produced or generated depending on a carrier signal, and in particular depending on a carrier frequency, with the aid of the optical transmission unit. This generated optical transfer signal can be provided or transferred to the radar sensor device via the glass fiber.

The optical reception unit can additionally comprise an evaluation unit, wherein the optical output signal received by the optical reception unit is to be evaluated and at least one radar information is to be generated by the evaluation unit. In particular, the optical reception unit is formed to convert the optical output signal and in particular to convert it into an electrical signal for the evaluation unit.

For example, the central electronic computing device can contain a fiber output and a fiber input. In particular, they are analog, optical inputs and outputs, respectively.

Similarly, the radar sensor device can comprise a fiber input as the optical input and a fiber output as the optical output.

With the aid of the glass fibers, the radar sensor device and the radar system are in particular bidirectionally connected to each other. Thus, a data exchange is effected in both directions. In particular, the radar sensor device can be connected to the radar system via a bidirectional interface. Thus, the radar sensor device can be used both for transmitting and for receiving signals. For example, the members or components of the reception path, in particular data reception path, can be connected to each other via copper cables. Thereto, preservation of coherence of individual, distributed reception modules of the reception path can be maintained at the same time.

A further aspect relates to a motor vehicle with a radar system according to the teachings herein or an embodiment therefrom. In particular, the just described motor vehicle includes a radar system according to the teachings herein.

In particular, the motor vehicle is an at least partially autonomously operated vehicle. In particular, the motor vehicle is a highly automated motor vehicle, which includes various driver assistance systems. These driver assistance systems can resort to the proposed radar system. In particular, the motor vehicle can comprise multiple such radar systems.

The motor vehicle is for example configured as a car, in particular as a passenger car or truck, or as a passenger bus or motorcycle.

A further aspect relates to a method for operating a radar sensor device according to one or more of the discussed embodiments, wherein it is switched between the transmission path and a reception path by the digital interface and one of the reception paths is enabled for receiving the electrical reception signal from the antenna by the digital interface, or one of the transmission paths is enabled for transmitting the electrical transmission signal by the antenna by the digital interface.

In particular, the just described method can be performed by a radar system, in particular by a radar transmission device of any one of the embodiments discussed.

For example, the digital interface unit can be applied by means of a functional principle similar to a MIMO method (“multiple-input-multiple-output”) or a SISO method (“single-input-single-output”). In particular, the radar sensor device is in the reception mode or reception operation in the basic setting, in particular in a default setting. Thereto, the digital interface unit can enable or activate the reception path for receiving the electrical reception signal from the antenna. During reception by means of the antenna, transmission is not possible. Thus, the transmission path is deactivated or turned off in the meantime. The digital interface unit can again switch into the transmission mode only immediately after transmitting the last transmission signal ramp of the transmission signal. Accordingly, it is switched from the transmission mode into the reception mode only shortly after the last emission of the last transmission ramp of the transmission signal. In analogous manner, the situation is inverse in switching from the reception mode into the transmission mode.

For example, after the end of the emission of the last transmission ramp of the electrical transmission signal, the transmission component or members of the transmission path can be turned off or deactivated and the reception components of the reception path can be turned on via a bus signal of the data transfer bus system. In particular, a duty cycle of the transmission signal is taken into account in switching between the transmission mode and the reception mode. In particular, the transmission components can be deactivated and the reception components can be activated with and/or without time delay. In particular, switching between the two modes is effected in a fraction of one second, in particular within one microsecond.

In particular if the transmission path is enabled, the reception path is deactivated. In analogous manner, the transmission path is deactivated or not enabled with an enabled reception path. This is in particular controlled and monitored by the digital interface unit and the control device.

A radar system for the motor vehicle also is a part of the teachings herein. The radar system comprises a processor device, which is configured to perform an embodiment of the method according to the teachings herein. Hereto, the processor device can comprise at least one microprocessor and/or at least one microcontroller and/or at least one FPGA (Field Programmable Gate Array) and/or at least one DSP (Digital Signal Processor). Furthermore, the processor device can comprise program code, which is configured, upon execution by the processor device, to perform one or more embodiment of the method according to the teachings herein. The program code can be stored in a data storage of the processor device.

A further aspect relates to a method for producing a radar sensor device according to one or more of the embodiments discussed herein, wherein the radar sensor device is produced as a system on a chip, and the electrical transmission path, the electrical reception path, the optical input, the optical output, the antenna and the digital interface unit are generated on the system on a chip. In particular, all of the components or members of the radar sensor device, as they were described to the embodiments of the previous aspects, are generated on the system on a chip. In other words, the radar sensor device is produced such that the radar sensor device is a single integrated circuit or a single semiconductor chip. Accordingly, all of the components or functional components associated with the radar sensor device are applied to one and the same semiconductor chip or integrated circuit.

Embodiments of individual aspects are to be regarded as beneficial embodiments of other aspects. In particular, the respective embodiments of individual aspects can be regarded as beneficial embodiments of all of the other aspects and vice versa.

The invention also includes the combinations of the described embodiments.

Embodiments of the radar system, of the motor vehicle and of the methods, which comprise features as they have already been described in context of the embodiments of the radar sensor device, also belong to the invention. For this reason, the corresponding embodiments of the radar system, of the motor vehicle, and of the methods are not again described here.

Reference will now be made to the drawings in which the various elements of embodiments will be given numerical designations and in which further embodiments will be discussed.

In the embodiments described herein, the described components of the embodiments each represent individual features that are to be considered independent of one another, in the combination as shown or described, and in combinations other than shown or described. In addition, the described embodiments can also be supplemented by features other than those described.

Specific references to components, process steps, and other elements are not intended to be limiting. Further, it is understood that like parts bear the same or similar reference numerals when referring to alternate FIGS.

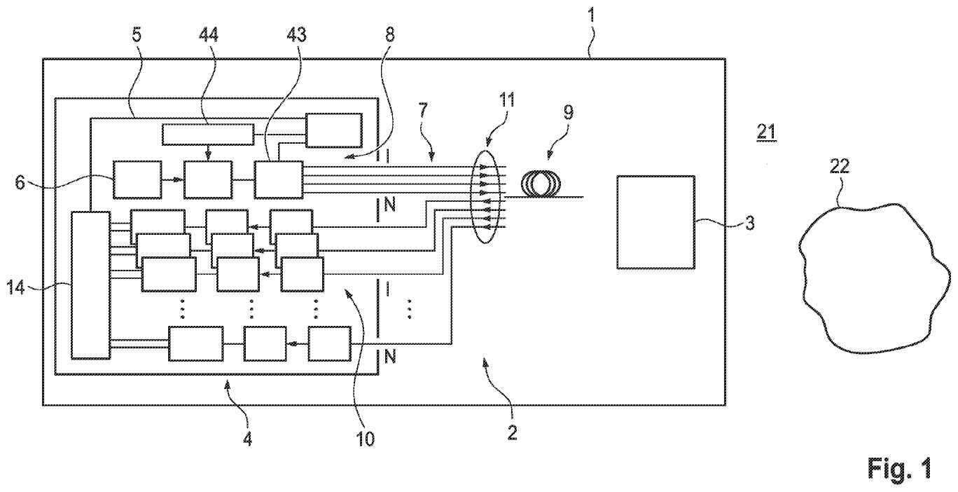

FIG. 1 shows a schematic top view to an embodiment of a motor vehicle 1. The motor vehicle 1 for example includes a radar system 2. The radar system 2 for example comprises a radar sensor device 3 and a central electronic computing device 4.

For example, the motor vehicle 1 can be formed as a highly automated vehicle or as an at least partially autonomously operated vehicle.

For example, the radar system 2 can be a sensor of a driver assistance system of the motor vehicle 1. For example, the radar system 2 can be a radar sensor or a lidar sensor or another sensor type. Besides the employment of the radar system 2 in the motor vehicle 1, it can also be employed in systems external to vehicle. For example, the radar system 2 can be applied in automated systems, in the aerospace technology, in the aeronautics technology or in the communication technology. Here, the example, in which the radar sensor 2 is integrated in a motor vehicle 1, is shown for illustration.

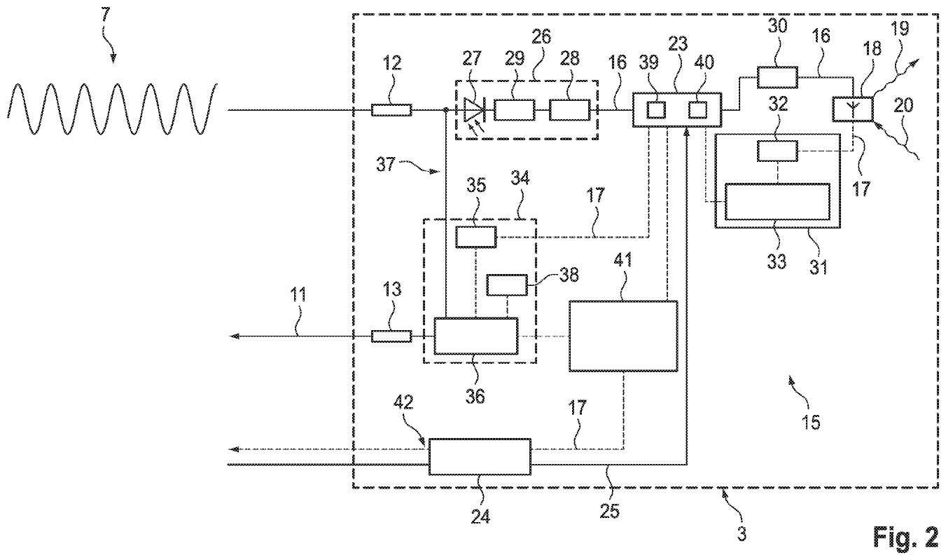

The radar system 2 comprises the central electronic computing device 4 separate and physically separated from the radar sensor device 3. The central electronic computing device 4 can for example be a central processing unit. The central electronic computing device 4 is formed for generating an electrical control signal 5. A laser device 6 of the central electronic computing device 4, which generates an optical transfer signal 7 for transferring to the radar sensor device 3 depending on an electrical control signal 5, is also provided. For example, the central electronic computing device 4 can comprise an optical transmission unit 8, which is configured to generate the optical transfer signal 7 and to couple it into at least one glass fiber 9. In particular, the central electronic computing device 4 comprises an optical reception unit 10. By means of the optical reception unit 10, an optical output signal 11 of the radar sensor device 3 can be received. The radar sensor device 3 is for example the transmission-reception unit of the radar system 2. Hereto, the central electronic computing device 4 is in particular respectively optically coupled to an optical input 12 and an optical output 13 of the radar sensor device 3 via at least one glass fiber 9, in particular glass fiber line. The optical input 12 and optical output 13 are not illustrated in FIG. 1 but are visible in FIG. 2. With the aid of the optical reception unit 10, the optical output signal 11 of the radar sensor device 3 can be received.

Further, the central electronic computing device 4 comprises at least one electronic evaluation unit 14. With the aid of the evaluation unit 14, the received optical output signal 11, which has for example been processed or converted into a digital signal by the optical reception unit 10, can be processed. Thus, at least one radar information can be derived and determined based on the optical output signal 11 with the aid of the evaluation unit 14. The optical output signal 11 can be referred to as optically modulated signal.

In particular, the optical input 12 is coupled to the central electronic computing device 4 by means of a glass fiber 9. Similarly, the optical output 13 is optically coupled to the central electronic computing device 4 via a glass fiber 9. In particular, the optical input 12 and the optical output 13 are respectively coupled to the central electronic computing device 4 by an own glass fiber 9 or by an own glass fiber bundle. Thus, a bidirectional communication, in particular via a bidirectional interface, can be provided between the central electronic computing device 4 and the radar sensor device 3.

In particular, a generation of an FMCW signal as well as the entire signal processing and evaluation can be performed by the central electronic computing device 4. Therein, the radar sensor device 3 can be composed of a single electronically-photonically correlated chip. Therein, there is in particular the technical possibility of performing the signal transfer of Gigahertz signals by means of an optical carrier signal in the Terahertz frequency range, which in particular corresponds to the optical transfer signal 7. Therein, the central electronic computing device 4 for example generates the optical carrier frequency. The signal to be transferred can be modulated on it with one eighth of the radar frequency of the radar system 2, which is represented by the block 44, and be transmitted to the radar sensor device 3 by glass fiber 9, in particular optical phase.

In this manner, a frequency multiplication, for example an eightfold increase of frequency, occurs such that the radar radiation of the radar system can be emitted by the radar sensor device 3. The signal detection occurs in the inverse way. All of the data is processed on the central electronic computing device 4.

For example, the trainer frequency can orient itself by a telecommunication window of the glass fiber 9, which is at 1300 nm and 1550 nm.

For example, the central electronic computing device 4 can comprise an optional 1:N switch 43, by means of which the optical transfer signal 7 can be provided on multiple channels for single or multiple radar sensor devices.

For example, the central electronic computing device 4 each comprises an optical coupling element corresponding to the optical input and optical output 12, 13. Therein, the optical input 12 and the optical output 13 can for example also be optical coupling elements of the radar sensor device 3.

For example, the optical transfer signal 7, consisting of a radar carrier signal with a carrier frequency and a radar ramp signal with a ramp frequency, can be generated by the central electronic computing device 4 in that they are modulated onto an optical carrier signal with a certain or preset carrier frequency. For example, this can be effected by the optical transmission unit 8.

FIG. 2 shows a schematic block diagram of an embodiment of the radar sensor device 3. In particular, the radar sensor device 3 can be formed as a system on a chip 15. In other words, the radar sensor device 3 only comprises one single integrated circuit or one single semiconductor chip. In particular, the radar sensor device 3 is formed as a photonically-electronically cointegrated semiconductor chip. In particular, the radar sensor device 3 is formed as a standalone unit and fully functionally equipped as a transmission and reception unit. Thus, the radar sensor device 3 is formed as a system on a chip 15 and the radar sensor device 3 in particular is a unit different and physically separated from the central electronic computing device 4.

The radar sensor device 3 as the system on a chip 15 can include both a transmission path 16 (illustrated by means of solid line in FIG. 2) and a reception path 17 (illustrated by means of dashed line in FIG. 2). Thus, this single chip design of this radar sensor device 3, which comprises only one single semiconductor chip or integrated circuit, includes both the transmission path 16, also referred to as Tₓ, and the reception path 17, also referred to as Rₓ channel. Thereby, compared to the radar devices of the prior art, instead of a respective chip for the reception unit and a chip for the transmission unit, all of the required components for transmitting and receiving can be integrated on one and the same chip, thus on the system on a chip 15. Thus, the radar sensor device 3 can be more compactly used and in particular better produced, since only one single chip has to be realized.

At the optical input 12, which is a constituent of the reception path 16, the optical transfer signal 7 is received and provided from the central electronic computing unit 4. At the optical output 13, which is a constituent of the reception path 17, the optical output signal 11 can be provided for transmitting or transferring to the central electronic computing unit 4.

For transmitting and receiving signals, the radar sensor device 3 comprises an antenna 18. By means of the antenna 18, an electrical transmission signal 19 can be transmitted on the one hand or an electrical reception signal 20 can be received.

The electrical transmission signal 19 is in particular an electrical signal based on the optical transfer signal 7. In other words, the optical transfer signal 7 is converted into the electrical transmission signal 19. The electrical transmission signal 19 converted from the optical transfer signal 7 can be transmitted for example into an environment 21 of the motor vehicle 1 by means of the antenna 18. The transmitted transmission signal 19 can for example impinge on an object 22 in the environment 21. Therein, the reflected electrical reception signal 20 corresponding to the electrical transmission signal 19 can in turn be received by means of the antenna 18.

In order that the radar sensor device 3 can either transmit the electrical transmission signal 19 or receive the electrical reception signal 20 by means of a single antenna 18, a digital interface unit 23 is provided. By means of the digital interface unit 23, which is integrated in the system on a chip 15 as a digital interface, the radar sensor device 3 can be operated either in a transmission mode or in a reception mode. This can be effected in that the digital interface unit 23 switches between the transmission path 16 for transmitting the electrical transmission signal 19 and the reception path 17 for receiving the electrical transmission signal 20. This switching can in particular be effected in a period of time in the microsecond range. For example, the switching between the transmission path 16 and the reception path 17 can be effected by means of the functional principle “MIMO” or “SISO”.

For example, the antenna 18 and the digital interface unit 23 can be a constituent both of the transmission path 16 and of the reception path 17. Thus, the antenna 18 and the digital interface unit 23 serve as functional units for the transmission mode as well as for the reception mode.

In order to be able to efficiently control the switching between the transmission path 16 and the reception path 17, a control device 24 can be integrated on the system on a chip 15 of the radar sensor device 3. The control device 24 can be used both for the transmission path 16 and for the reception path 17. For example, the control device 24 can be linked to the central electronic computing unit 4 or to another electronic computing unit of the radar system 2 or of the motor vehicle 1. In particular, the control device 24 is a diagnostic and control interface. In other words, the digital interface unit 23 can be driven for switching between the transmission path 16 and the reception path 17 with the aid of the electronic control device 24. For this driving, the control device 24 can be communicatively linked to the digital interface unit 23 via a data transfer bus system 25. The data transfer bus system 25 is a data transfer network. With the aid of the data transfer bus system 25, control signals of the control device 24 can be transferred to the digital interface unit 23 for switching between the transmission path 16 and the reception path 17. In particular, all of the components of the radar sensor device 3 can be linked to each other or among each other with the aid of the data transfer bus system 25. In particular, the control device 24 is integrated on the system on a chip 15.

The data transfer bus system 25 is in particular a network or transfer path separate from the transmission path 16 and reception path 17.

In particular, the members or components of the transmission path 16 and of the reception path 17 can be connected or wired or linked to each other via electrical signal lines, in particular copper cables or copper traces.

For example, a transformation device 26 can be integrated or formed on the system on a chip 15 of the radar sensor device 3. The transformation device 26 is in particular interconnected or wired immediately after the optical input 12, in particular to an output side of the optical input 12. In particular, the transformation device 26 is interconnected between the optical input 12 and the digital interface unit 23. With the aid of the transformation device 26, the electrical transmission signal 19 can be produced or generated depending on the received optical transfer signal 7. Thereto, the transformation device 26 comprises at least one optical photodiode 27. In particular, the transformation device 26 and the optical photodiode 27 are a constituent of the transmission path 16. With the aid of the optical photodiode 27, optical signals can be converted into electrical signals, thus here the optical transfer signal 7 into the electrical transmission signal 19.

Furthermore, the transformation device 26 can comprise an amplifier unit 28, in particular a frequency multiplier unit. With the aid of the amplifier unit 28, a frequency of the transmission signal 19 generated by the optical photodiode 27 can be increased in the frequency thereof. Therein, the frequency of the converted transmission signal 19 is in particular adapted to the carrier frequency. Thus, a frequency increase of the transmission signal 19 is performed here. The conversion of the optical transfer signal 7 and in particular the frequency increase can for example be effected by a check unit 29, which can be referred to as TIA. The check unit 29 is in particular a constituent of the transformation device 26.

A further constituent of the transmission path 16 is a transmission amplifier unit 30. The transmission amplifier unit 30 can be arranged or integrated or wired between the digital interface unit 23 and the antenna 18. With the aid of the transmission amplifier unit 30, a transmission power of the antenna can be increased or amplified for transmitting the electrical transmission signal 19. In particular, the transmission amplifier unit 30 is a power amplifier.

In the following, the components or members of the reception path 17 are explained in more detail. The reception path 17 can comprise a demodulation circuit 31. It can in particular be interconnected between the antenna 18 and the digital interface unit 23.

In particular, the transmission path 16 and the reception path 17 are two paths physically separated from each other.

The received electrical reception signal 20 can be conditioned with the aid of the demodulation circuit 31. For example, the demodulation circuit 31 can comprise at least one IQ mixer 32. The received electrical reception signal 20 can be digitally modulated with the aid of the IQ mixer. Therein, very different modulation methods can be applied. The received electrical reception signal 20 can be mixed with the electrical transmission signal 19 with the aid of the IQ mixer 32. Subsequently, this mixed signal can be processed in the form of I and Q data in a baseband signal processing unit 33 of the demodulation circuit 31. The baseband signal processing unit 33 modulates the I and Q data for example onto an electrical carrier frequency. In particular, the reception is controlled by means of the digital interface unit 23.

In particular, it is also to be mentioned that all of the components of the reception path 17 are deactivated and only the components for transmitting the transmission signal 19 are activated in transmitting the transmission signal 19 by means of the control device 24 and the digital interface unit 23. The situation is inverse in receiving the reception signal 20.

For further processing the received and in particular conditioned electrical reception signal 20, the radar sensor device 3 can comprise a modulation device 34. The modulation device 34 is in particular also a constituent of the reception path 17. For example, the mixed and processed signal can be modulated onto the optical transfer signal 7 by the demodulation circuit 31, subsequently by means of a driver unit 35 of the modulation device 34 by an optical modulation unit 36 of the modulation device 34. For example, the modulation unit 36 can be a Mach-Zehnder modulator. The optical transfer signal 7 can be provided or supplied to the modulation unit 36 via an optical branch 37 from the optical input 12. Accordingly, the optical output signal 11 modulated in the modulation unit 36 of the modulation device 34 can be coupled into the glass fiber 9 via the optical output 13 and transferred or communicated to the central electronic computing device 4.

In particular, the modulation device 34 is interconnected between the optical output 13 and the digital interface unit 23.

Furthermore, the modulation device 34 can comprise a check unit 38, also referred to as “bias”. The modulation operation can be monitored by it.

In order that the data transfer in the transmission path 16 and the reception path 17 can be better and faster performed, it is beneficial if a respective digital data load can be reduced in the transfer of the respective signals. This is achieved by the digital interface unit 23 on the one hand.

In order to keep the data load low during the transmission mode and the reception mode, the digital interface unit 23 can comprise an analog-digital converter (ADC) 39. In addition, the digital interface unit 23 can comprise a data compression unit 40 or compression interface. The electrical signals can be digitally converted and digitally compressed by the analog-digital converter 39 and/or the data compression unit 40. Thus, a data load for transmitting and receiving can be compressed and in particular reduced. Thus, the digital interface unit 23 can be more efficiently operated.

A further possibility of being able of reducing the data load in the transmission mode and reception mode is the use of an optional data pre-processing device 41 of the radar sensor device 3. The data pre-processing device 41 is in particular a constituent of the reception path 20. The data pre-processing device 41 can in particular be referred to as “low-level signal processing unit”. For data compression or data reduction, the data pre-processing device 41 can use an algorithm for performing an FFT process (“fast Fourier transform”). In other words, the electrical reception signal 20 can be conditioned with the aid of the data pre-processing device 41.

In order to be able to more extensively and effectively use the radar sensor device 3, the radar sensor device 3 can comprise an electrical output 42 alternatively or additionally to the optical output 13. The optical output 42 can be a constituent of the reception path 17. With the aid of the electrical output 42, the electrical reception signal 20 or the mixed signal of the demodulation circuit 31 can be directly output to the central electronic computing device 4 or another electrical computing unit without the optical conversion into the optical output signal 11. Thus, according to case of application, the electrical reception signal 20 can be directly further communicated without intermediate processing or conversion steps.

In particular, the data pre-processing device 41 can be interconnected between the modulation device 34 and the digital interface unit 23. In particular, the data pre-processing device 41 can be interconnected between the digital interface unit 23 and the electrical output 42.

A method not illustrated here can be used for producing the radar sensor device 3. In this production method, the radar sensor device 3 can be produced as a system on a chip 15 as a primary production process step. Thus, the radar sensor device 3 is produced as a single semiconductor chip or electronically-photonically integrated circuit. In the production process of the radar sensor device 3, the electrical transmission path 16, the electrical reception path 17, the optical input 12, the optical output 13, the antenna 18, the electrical output 42, the transformation device 26, the digital interface unit 23, the transmission amplifier unit 30, the demodulation circuit 31, the modulation device 34, the data pre-processing device 41 as well as the control device 24 are additionally generated on or applied to the system on a chip 15 in the production process of the radar sensor device 3. In other words, all of the electronic, electrical and photonic members of functional units of the radar sensor device 3 are arranged or applied or installed or integrated on one and the same system on a chip 15. Thus, all of the members of the radar sensor device 3 are applied to one and the same chip in one and the same production process.

Furthermore, a method not illustrated here can be used to correspondingly drive or use the digital interface unit 23, in particular with the aid of the control device 24, such that it can be switched either to the transmission path 16 or the reception path 17. For example, the reception path 17 can be enabled for receiving the electrical reception signal 20 from the antenna 18 by the digital interface unit 23. Therein, the reception mode of the radar sensor device 3 is set in this state. In this state, transmission of the transmission signal 19 is not possible. Herein, the components of the transmission path 16 are in particular turned off or deactivated. After or immediately after receiving the last signal reception ramp of the reception signal 20, switching from the reception mode into the transmission mode can be initiated by the digital interface unit 23. In particular, the components of the reception path 17 can be activated and the components of the transmission path 16 can be deactivated by means of the transfer bus system 25.

The situation is inverse in the transmission mode, which can be activated by the digital interface unit by enabling the transmission path 16. After or immediately after the emission of the last signal transmission ramp, in particular of the duty cycle, of the electrical transmission signal 19, the components of the transmission path 16 can be turned off or deactivated and the components of the reception path 17 can be turned on with the aid of the control device 24 with and/or without time delay via a bus signal of the data transfer bus system 25. Thus, either the components of the transmission path 16 or the components of the reception path 17 are switched to active.

By the described embodiments of FIG. 1 and FIG. 2, a reduction of a data transfer load in a radar system with distributed antennas can in particular be performed. Thereto, an integration of digital interfaces in the photonically, electronically cointegrated semiconductor chip for receiving radar radiation for digitalization, signal pre-processing and data compression of the raw signals can be applied. For example, these raw signals can be highly precisely timestamped both via optical interfaces and via electronic interfaces such that a coherent or quasi-coherent or incoherent processing can be performed in the central station.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A radar sensor device, comprising:
a transmission path;
a reception path different from the transmission path;
an optical input, which is a part of the transmission path and which is formed for receiving an optical transfer signal;
an optical output, which is a part of the reception path and which is formed for providing an optical output signal;
an antenna, which is configured to transmit an electrical transmission signal, which is based on the optical transfer signal, and to receive an electrical reception signal;
digital interface, which is configured to switch between the transmission path for transmitting the electrical transmission signal and the reception path for receiving the electrical reception signal; wherein
the radar sensor device is formed as a system on a chip; and
the transmission path, the reception path, the optical input, the optical output, the antenna and the digital interface unit are arranged on the system on a chip.

2. The radar sensor device of claim 1, comprising a transformation device, which is arranged on the system on a chip and formed to generate the electrical transmission signal depending on the received optical transfer signal.

3. The radar sensor device of claim 2, wherein the transformation device comprises an amplifier, wherein the amplifier is formed to increase a frequency of the electrical transmission signal generated by the optical photodiode depending on a preset carrier frequency.

4. The radar sensor device of claim 1, wherein the antenna and the digital interface are components of the transmission path and of the reception path.

5. The radar sensor device of claim 1, wherein the transmission path between the digital interface and the antenna comprises at least one transmission amplifier, wherein the transmission amplifier is formed to increase a transmission power of the antenna for transmitting the electrical transmission signal.

6. The radar sensor device of claim 1, wherein the reception path between the digital interface and the antenna comprises a demodulation circuit, wherein the demodulation circuit is configured to mix the received electrical reception signal with the electrical transmission signal.

7. The radar sensor device of claim 6, comprising a modulation circuit, which is arranged on the system on a chip and configured to generate the optical output signal depending on the electrical reception signal.

8. The radar sensor device of claim 1, wherein the digital interface comprises an analog-digital converter, wherein the analog-digital converter is configured to digitally convert and digitally compress the received electrical reception signal.

9. The radar sensor device of claim 1, comprising:
at least one electrical output different from the optical output, which is arranged on the system on a chip and formed to output the electrical reception signal of the reception path, and
a data pre-processing circuit, which is arranged on the system on a chip and by which the received electrical reception signal can be conditioned.

10. The radar sensor device of claim 1, comprising a control device, which is arranged on the system on a chip and which is configured to drive the digital interface of the radar sensor device such that the radar sensor device is switched either to the transmission path or to the reception path.

11. A radar system with at least one radar sensor device according to claim 1 and a central electronic computing circuit, wherein
the central electronic computing circuit is configured to generate the optical transfer signal for the radar sensor device and to receive the optical output signal; and
the central electronic computing circuit is respectively coupled to the optical input and to the optical output of the radar sensor device via at least one glass fiber.

12. The radar system of claim 11, wherein
the central electronic computing circuit comprises an optical transmission unit, which is configured to generate the optical transfer signal and to couple it into the at least one glass fiber, which is coupled to the optical input of the radar sensor device; and
the central electronic computing circuit comprises an optical reception unit, which is configured to receive the optical output signal via the at least one glass fiber, which is coupled to the optical output of the radar sensor devices, and to determine radar information derived from it.

13. A motor vehicle with a radar system of claim 11.

14. A method for operating a radar sensor device of claim 1, wherein it is switched between the transmission path and the reception path by the digital interface unit, and
the reception path is enabled for receiving the electrical reception signal from the antenna by the digital interface, or
the transmission path is enabled for transmitting the electrical transmission signal by the antenna by the digital interface.

15. A method for producing a radar sensor device of claim 1, wherein
the radar sensor device is produced as a system on a chip, and
the electrical transmission path, the electrical reception path, the optical input, the optical output, the antenna and the digital interface are generated on the system on a chip.

16. The radar sensor device of claim 1, wherein the transformation device comprises an optical photodiode for generating the electrical transmission signal depending on the optical transfer signal.

17. The radar sensor device of claim 2, wherein the antenna and the digital interface are components of the transmission path and of the reception path.

18. The radar sensor device of claim 3, wherein the antenna and the digital interface are components of the transmission path and of the reception path.

19. The radar sensor device of claim 7, wherein the modulation circuit is configured to modulate the mixed signal onto the optical transfer signal and to provide it as an optical output signal at the optical output.

20. The radar sensor device of claim 10, wherein the control device comprises a data transfer bus system, wherein the control device is communicatively linked to the digital interface unit by the data transfer bus system.
